(19) United States
(12) Patent Application Publication
(10) Pub. No.: US 2005/0228702 A1
(43) Pub. Date: Oct. 13, 2005

(54) Devices, systems, and methods for providing remaining seat availability information in a booking class

(75) Inventors: Christopher Jon Fairbanks, Brooklyn, NY (US); Brian Davis Richardson, Dallas, TX (US); Alice H. Kang, New York, NY (US); Fayyaz H. Shah, Garland, TX (US); Joshua Hartmann, New York, NY (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Travelocity.com LP

(21) Appl. No.: 10/981,375

(22) Filed: Nov. 3, 2004

Related U.S. Application Data
(60) Provisional application No. 60/557,632, filed on Mar. 30, 2004.

(51) Int. Cl. G06F 17/60

(52) U.S. Cl. 705/5

(57) ABSTRACT

A computer device is provided for determining remaining seats in a booking class having a maximum number of seats, which communicates with a user's computer device over a network to receive a user query, associated with travel parameters and including an amount of persons and at least two connect points, and obtains a schedule corresponding thereto. The schedule includes a cabin class with booking classes ranked by a criteria between a highest and a lowest booking class, the lowest booking class being a subset of the highest booking class. The computer device selects a least-cost-fare booking class from the ranked booking classes, which has an actual number of available seats at least equal to the amount of persons requesting seats and an applicable fare meeting the travel parameters, and provides an indicia thereof to the user, in direct response to the query. Associated systems and methods are also provided.

### CROSS-REFERENCE TO RELATED APPLICATIONS

This application claims the benefit of U.S. Provisional Application No. 60/557,632, filed Mar. 30, 2004.

### BACKGROUND OF THE INVENTION

1. Field of the Invention

The present invention relates generally to determining airline seat availability information and, more particularly, to a device, system, and method for providing remaining seat availability information in a booking class of seats.

2. Description of Related Art

An important issue with regard to the sale of most products is availability of the product at the point of sale. That is, when a consumer is shopping for a particular product, one impetus for the consumer to pursue the transaction at that time (or to postpone the purchase for a later time) may be the availability, or lack thereof, of the product. Some products may have, for example, complex pricing structures, availability determination procedures, inventory management procedures, specified marketing controls, etc. These complex structures and procedures require complex computing software to properly handle administration of the product and inventory management. As a result, it may be difficult, if not impossible, for the consumer to determine actual availability when shopping for the product.

For example, airline tickets may include several cabin classes, such as first class, business, and coach, wherein each such cabin class may also include a variety of different booking classes, each associated with a set or plurality of fares, that are treated differently, such as Y, B, and M booking classes within a coach cabin class. Further, each of the fares associated with each of the booking classes may have different marketing controls, restrictions, advance purchase requirements, etc. Different airlines may also use different inventory control methodologies to calculate availability of tickets, such as sub-type nesting, sub-component nesting, static virtual nesting, dynamic virtual nesting, continuous nesting, etc., and different inventory adjustment methodologies to control inventory management, such as net availability, net availability with capping, and threshold availability. Such complexities contribute to the difficulty in a travel shopper determining seat availability or how many seats remain in a cabin class and/or booking class when shopping for travel schedules or itineraries.

Typically, when online shopping for airfares for a desired schedule or itinerary, a consumer uses a computer terminal to connect to and communicate with an online travel service over a computer network, such as the Internet. The consumer is generally required to input basic information about the desired travel schedule such as, for example, origin, destination, departure and return dates and times, and number of persons or travelers requesting seats. In response to this input, the travel service uses travel parameters from the consumer's inquiry and the origin and destination connect points to develop or otherwise retrieve one or more carrier schedules therebetween. The appropriate schedules are then presented on a summary display to the consumer, at the consumer's computer terminal, and include flight information such as departure and arrival times, as well as the price for a seat or ticket on that flight. That is, the customer may be presented with a list of available flights, each with a corresponding price. In such instances, when the consumer then chooses a particular flight or schedule and proceeds to request more information about a particular quoted flight or schedule or has actually proceeded to purchase the tickets, only then may the consumer be provided with some indication of seat availability. In other instances, the customer may be presented with a list of available flights and must then select a particular flight in order to be provided with the corresponding price information. In still other instances, the customer may be provided with a list of prices with each price corresponding to the available travel dates and the particular flights on each date.

However, in any instance, the information provided to the customer in response to the customer's inquiry may not be provided or may not be specific with respect to seat availability for a particular cabin class. Such information with respect to seat availability provided to the customer may also be difficult for an uninformed consumer to interpret. For example, upon selecting a particular flight or schedule, the consumer may be provided with a seat map of the particular cabin class, for which a ticket was quoted at a particular price, showing the available seats so as to allow the consumer to select one or more seats within that cabin class or to change seat assignments. In other instances, after selecting a particular flight, the consumer may be provided with information such as “Y7 B7 H7 K7 M7 Q7,” which represents airline designations for available seats in a cabin class or over a range of booking classes. Such terminology may be indecipherable by an uninformed consumer unfamiliar with such terminology used by airlines.

If the consumer decides not to commit to the purchase of a ticket for the flight, schedule, or itinerary at that time, but to return to the travel site at a later time to purchase the tickets, the consumer may find that, though seats are still available for the particular flight schedule, the price may have changed considerably because seats may no longer be available in the same booking class as when the ticket price was originally quoted or the later inquiry may no longer meet certain restrictions or limitation associated with the previously-quoted price. In some instances, the price for that same schedule may have increased significantly, and the consumer may decide not to purchase that ticket at all, or to investigate other schedules or airlines. The end result may be a lost sale, which may have been otherwise been completed at the earlier time had the consumer been informed of the particular availability of seats at the original quoted price upon the original inquiry. Thus, there exists a need for informing the consumer, in a more direct and understandable manner, of the particular availability of seats or tickets at a quoted price in order to allow the consumer to make an informed decision whether to purchase the ticket(s) at the time of the price quote.

### BRIEF SUMMARY OF THE INVENTION

The above and other needs are met by the present invention which, in one embodiment, provides a method of determining a remaining amount of seats available in at least one booking class, wherein the method is implemented over a computer network. Each booking class includes a maximum number of available seats and a plurality of fares associated therewith. First, a query from a user is received over the computer network, wherein the query is associated with travel parameters and includes an amount of persons requesting seats and at least two connect points to be traversed. At least one schedule between the at least two connect points is then obtained. Each schedule includes at least one travel segment, and each travel segment has at least one cabin class associated therewith. Each cabin class includes at least one booking class, and the booking classes in each respective cabin class are ranked according to a booking class criteria so as to include a highest booking class and a lowest booking class, with each booking class lower than the highest booking class being a subset of the highest booking class. Each booking class may also be associated with a plurality of fares each having a price, wherein the appropriate fare is determined by various factors including, for example, availability, restrictions, and date of purchase. A least-cost-fare booking class is then selected from the ranked booking classes, wherein the least-cost-fare booking class is the booking class having an actual number of available seats at least equal to the amount of persons requesting seats and an applicable fare from the plurality of fares meeting the travel parameters associated with the query. An indicia of the number of available seats in the least-cost-fare booking class is thereafter provided via the computer network to the user in direct response to the query.

Another advantageous aspect of the present invention comprises a system for implementing the associated method of determining a remaining amount of seats available in at least one booking class, as described herein. Such a system may be implemented in computer hardware, software, or a combination of computer software and hardware, having one or more executable and/or processing portions for accomplishing an associated method according to other embodiments of the present invention. In a representative embodiment, a travel system is at least partially initiated and established on an intermediary computer or computer device, capable of implementing the described associated method, that is part of a larger computer network such as, for example, the Internet. Such an intermediary computer or computer device may comprise, for example, a desktop personal computer, a laptop personal computer, a server, a router, a mainframe computer or like devices or combinations thereof capable of implementing the described functions as known to one skilled in the art. Once established on the intermediary computer or computer device, the travel system is accessible to a customer (also referred to herein as “user” or “consumer”) via a user's computer device (also comprising a part of the travel system) that is discrete with respect to the intermediary computer or computer device, but capable of communicating with the computer network and, as a result, with the intermediary computer or computer device through, for example, network communication lines.

Thus, embodiments of the present invention provide a device, system, and method capable of providing an indicia of the number of available seats in a least-cost-fare booking class to the user in direct response to a query from the user regarding particular travel plans. That is, in response to the user's query regarding particular travel parameters, embodiments of the present invention provide the user with one or more corresponding travel schedules meeting the travel parameters, each having a price or cost associated therewith, in direct response to the query. Advantageously, the direct response also includes an indicia of how many seats or tickets remain available, at the time of the response, at the quoted price. The user is then able to make an objective purchasing decision based upon the actual availability, or lack thereof, of tickets corresponding to the quoted price. When provided the immediate seat availability for a quoted price, the user may be able to assess the likelihood of seat availability at the quoted price at a later time, and thereby make a better judgment of the timing of the purchase. Embodiments of the present invention may thus be able to capture sales for a travel provider that may otherwise have been lost due to higher price quotes for a travel ticket at a later time due, in part, to procrastination on the part of the user, while also providing savings and value to both the user (buyer) and the travel provider. Therefore, devices, systems, and methods for determining a remaining amount of seats available in at least one booking class, according to embodiments of the present invention, provide significant advantages as detailed herein.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic representation of a system for determining a remaining amount of seats available in at least one booking class, according to one embodiment of the present invention;

FIG. 2 is a schematic representation of data from which a remaining amount of seats available in at least one booking class can be determined, according to one embodiment of the present invention; and

FIG. 3 is schematic representations of system for providing a direct response to a user's query, the direct response including a remaining amount of seats available in at least one booking class at a quoted price, according to one embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

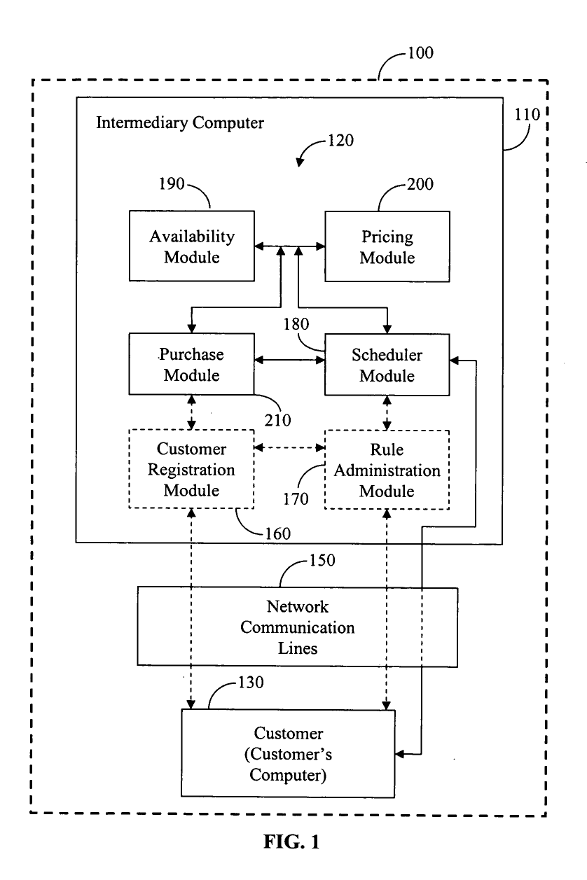

FIG. 1 is a schematic representation of a system, operating over a computer network, for determining a remaining amount of seats available in at least one booking class, according to one embodiment of the present invention, and is representative of a system capable of implementing a method of determining a remaining amount of seats available in at least one booking class in accordance with further embodiments of the present invention. The travel system 120 is initiated, developed, and administered on an intermediary computer or other computer device 110, wherein the intermediary computer or other computer device 110 is part of a larger computer network 100 such as, for example, the Internet. Such an intermediary computer or computer device 110, referred to herein as “intermediary computer 110” for convenience and brevity, may comprise, for example, a desktop personal computer, a laptop personal computer, a server, a router, a mainframe computer or like devices or combinations thereof capable of implementing the functions and methods described herein as will be appreciated by one skilled in the art.

Once established on the intermediary computer 110, the system 120 is accessible to a customer through a customer's computer 130, referred to herein as “customer 130” for convenience and brevity, capable of communicating with the computer network 100 and communicable with the intermediary computer 110 through, for example, network communication lines 150. Note that, while a simple schematic of a single computer device in communication with a computer network is presented herein, it is understood that this concept is representative of communication through an Internet site on, for example, the World Wide Web, and may involve many different computers and associated equipment, wherein the concept of communication via the Internet is known to one skilled in the art. Note that the intermediary computer 110 is typically remote from, discrete, and independent of the customer 130. However, in some instances, embodiments of the system and corresponding method described herein as being performed by the intermediary computer 110 may be hosted by a customer's computer 130, in which case the customer's computer 130 may also serve as the intermediary computer 110 consistent with the spirit and scope of the present invention.

In order to explore the resources offered by the travel system 120 such as, for example, to search for travel schedules or itineraries, each associated with a price, between an origin and a destination, the customer 130 accesses the intermediary computer 110 over the network communication lines 150. Generally associated with the travel system 120 on the intermediary computer 110 are an optional customer registration module 160, an optional rule administration module 170, a scheduler module 180, an availability module 190, a pricing module 200, and a purchase module 210. The customer 130 may be, in some instances, required to register with the customer registration module 160 via the network communication lines 150 so as to be able to access and utilize the travel system 120 and/or execute a transaction through the purchase module 210. In other instances, the customer 130 may not be required to register with the customer registration module 160 until immediately prior to executing a transaction through the purchase module 210. In still other instances, the customer registration module 160 may be an optional component of the system 120, wherein such a system 120 would not require customer registration in order to access the services offered by the system 120. Accordingly, the customer registration module 160 is shown in phantom in FIG. 1 in order to signify the optional nature of the customer registration module 160. Note that the customer's computer 130 may generally comprise any computer device or terminal configured to be communicable with the intermediary computer 110, wherein a single computer device or terminal may, in some instances, comprise one or more of the computer elements. For example, a single computer device may comprise both the customer's computer 130 and the intermediary computer 110 where an entity, such as a travel agent or broker, buys travel tickets as a customer and implements a travel system 120, such as that implemented on the intermediary computer 110, to resell the tickets.

The travel system 120 is generally implemented in computer software, though the system 120 may also, in some instances, be implemented in a combination of software and hardware. The information gathered through the optional customer registration module 160, the optional rule administration module 170, and/or the purchase module 210 is generally stored in, for example, one or more databases in a memory device (not shown) incorporated within or otherwise associated with the intermediary computer 110. Accordingly, the system 120 may provide data mining opportunities as will be realized by one skilled in the art. Further, the optional customer registration module 160, the optional rule administration module 170, the scheduler module 180, the availability module 190, the pricing module 200, and the purchase module 210 are typically implemented in computer software, though these components may be implemented by a combination of software and hardware, in some instances. For example, the scheduler module 180 may include or be disposed in communication with a router, server, switch, or the like, for appropriately allowing access thereto for listing schedules by travel carrier and/or searching and selecting schedules by a travel agent or other intermediary. In addition, the scheduler module 180 may comprise, for instance, a display, a driver, or other mechanism for presenting text, graphics, audio, or the like to confirm an entity's interactions with the scheduler module 180 or other information associated therewith through the system 120. Generally, these elements or modules cooperate to form the system 120, implemented in computer software or a combination of software and hardware, including one or more processing portions capable of executing embodiments of a method of determining a remaining amount of seats available in at least one booking class according to the present invention. Thus, embodiments of such methods according to the present invention may be implemented by one or more corresponding processing portions of an associated system or computer device, wherein each processing portion may comprise a software component, or both a software and hardware component, capable of implementing one or more of the specified functions. An associated computer software program product may also be provided, wherein such a computer software program product may include one or more executable portions capable of being executed by an appropriate computer device to perform any or all of the methods described herein. Accordingly, the operation of the travel system 120 and its associated elements may be more particularly illustrated from the description of an associated method corresponding to one embodiment of the present invention.

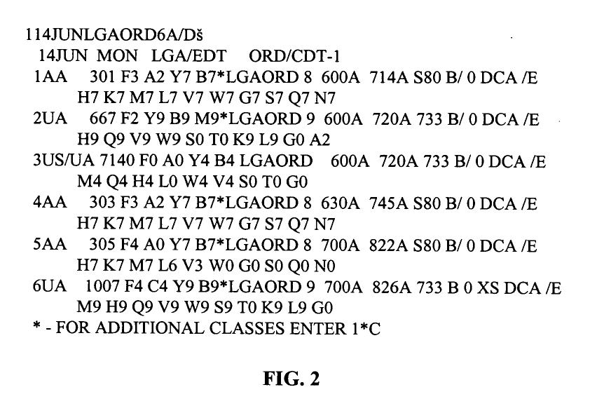

FIG. 2 is a schematic representation of data from which a remaining amount of seats available in at least one booking class can be determined, according to one embodiment of the present invention, using a system 120 as shown in FIG. 1. As detailed herein, the described method may allude to a representative example involving the airline travel industry where the customer 130 is, for example, a person seeking airline tickets for travel between an origin and a destination, on a particular date and time, and for a particular number of travelers, and the intermediary computer 110 represents, for instance, an online travel service such as, for example, Travelocity.com, which is capable of receiving the customer's parameters and, in response, providing the customer 130 with various options for completing the trip. However, it will be understood that the present invention is not limited to the airline travel industry, but may include and be applicable to a variety of industries such as, for example, rail travel, cruise or other on-water travel, or accommodations, wherein the particular industry implements a cabin class/booking class system in providing a price quote to a customer. Thus, the examples presented herein are not intended to be inclusive or to limit the applicability of embodiments of the present invention, but are presented to illustrate possible applications consistent with the spirit and scope of the present invention.

A customer or user 130 investigating travel schedules or itineraries first connects with an online travel system 120 via the intermediary computer 110 over the network communication lines 150. Upon connection with the travel system 120, the user 130 is prompted to provide one or more travel parameters (also referred to herein as “a query”) which may include, for example, trip origin, trip destination, dates and times for departure and/or return, and the number of persons or travelers requesting seats. The responses provided by the user 130 are received by the optional rule administration module 170, in some instances, via a user interface (not shown) which may be integral with or discrete with respect to the optional rule administration module 170, as will be appreciated by one skilled in the art. The optional rule administration module 170 may comprise appropriate rules or other functionality for determining one or more search or restriction parameters from the query provided by the user 130. For example, the number or persons requesting seats may be treated as persons traveling together who would prefer a pair of adjacent seats. In other instances, the date of the request as compared to the date of travel (advance ticketing) may comprise a restriction parameter or may be related to certain black-out dates. The maximum number of connections may also factor into the search parameters. The instances presented herein in terms of rules administered by the optional rule administration module 170 are provided solely for example and are not intended to be restrictive in any manner with respect to the capabilities of the optional rule administration module 170. One skilled in the art will also appreciate that, in some instances, the rule administration module 170 may not be included in the system 120, wherein the functionality of the rule administration module 170 may, instead, be included in one or more of the other components of the system 120 as described herein. For example, the functionality related to evaluation and/or execution of search and/or restriction parameters may be implemented by the scheduler module 180, the availability module 190, and/or the pricing module 200, as appropriate. Accordingly, the rule administration module 170 is shown in phantom in FIG. 1 in order to signify the optional nature of the rule administration module 170.

In embodiments of the travel system 120 where the customer registration module 160 is used, the customer registration module 160 may require the customer or user 130 to provide, for example, contact information or other personal information for the traveler, and payment (credit card) information. In some instances, however, registration or logon via the customer registration module 160, may only be required immediately prior to completing a transaction via the purchase module 210. In other instances, the customer registration module 160 may not be provided and any functionality associated therewith regarding any customer registration requirements may be handled by, for example, an appropriately configured purchase module 210. It will thus be appreciated by one skilled in the art that any registration requirements and/or transaction functionality may be implemented in many different forms consistent with goals of the system 120 and the spirit and scope of the present invention.

Upon determining the appropriate search and/or restriction parameters, the optional rule administration module 170 and/or a scheduler module 180 proceed to process the parameters in order to develop an appropriate search. The scheduler module 180 may comprise appropriate rules or other functionality for determining one or more airports or “connect points” on the route requested by the user 130, wherein the connect points may be determined according to business parameters such as, for example, the price of the ticket or schedule, or the travel time involving a connect point. In addition, the scheduler module 180 may comprise appropriate rules or other functionality for determining one or more schedules between the origin and destination connect points wherein other business parameters, such as, for example, a particular carrier serving the particular connect points, may also affect the determined schedules.

In determining the one or more appropriate schedules meeting the user's criteria, the optional rule administration module 170 and/or the scheduler module 180 may also communicate with the availability module 190 in order to determine seat availability for the flight or travel segments of the schedules. That is, the availability module 190, upon being provided with the selected schedule(s) or other parameters, applies appropriate rules or other functionality for determining seat availability, wherein the seat availability may be investigated under, for example, a cabin or booking class criteria. A cabin class criteria may restrict the seat availability determination to a particular cabin class such as, for instance, first cabin class seats, business cabin class seats, or coach cabin class seats. In performing the seat availability determination, the availability module 190 may implement a direct connect availability procedure to communicate in real time with the travel carrier identified by each schedule or travel segment therein, so as to determine seat availability directly from the carrier. In other instances, the availability module 190 may implement a cached availability procedure, wherein a periodically-updated cache of travel carrier seat availability information is queried so as to determine seat availability for each schedule or travel segment therein. One skilled in the art will appreciate, however, that other systems and methods may provide the necessary seat availability information.

One manner of indicating seat availability uses, for example, a nesting hierarchy, for indicating one or more booking classes within a cabin class. For instance, in continuance of a previous example, “Y7 B7 H7 K7 M7 Q7” may indicate various booking classes within a coach cabin class, where “Y” may represent a full priced fare coach cabin class ticket (highest booking class) for a particular flight, while “K” may represent a booking class with lower priced fares (lower booking class) that is a subset of the “Y” class, wherein the “K” booking class fares may carry restrictions, advanced purchase requirements, and/or limited or no refundability requirements, or the like (fare restrictions or requirements). The numerals following the letters generally indicate a number of available seats in each booking class, the significance of which is discussed further herein. Fares associated with the “M” and “Q” booking class tickets may carry additional restrictions over the “K” class, where “M” may be a subset of “K,” and “Q” (most restricted booking class) a subset of “M.” That is, for a particular flight, a total number of coach cabin class seats may be available, for example, 100 seats, that may all be sold at full fare (full price) with little or no restrictions (“Y”). However, of those 100 seats, 20 seats may be designated as being available with certain restrictions (“K”), while 10 of those “K” class seats may have different eligibility criteria and may thus be cheaper or lower priced (i.e. “M” class). There may be, however, several different schemes of managing such a hierarchy and, in general, the more restricted booking classes are associated with fares which are often less costly with respect to price than the least-restricted booking class. In some instances, the progression from the least restricted, higher cost booking class to the more restricted, lower cost booking class may be listed with respect to cost or restrictions, but will generally include a highest booking class and a lowest booking class. One skilled in the art will appreciate that, though the discussion herein refers to booking classes within a coach cabin class, the same principles are also applicable to other cabin classes such as the first cabin class or the business cabin class, wherein each such cabin class may independently include one or more booking classes.

For example, in a serial nested inventory scheme, if a “K” class ticket is sold, each of the other lower hierarchy booking classes “M” and “Q” are decremented by 1, since there would be one less ticket to be sold in the lower booking classes. Further, the upper hierarchy booking class “B” is also decremented by 1 and, since class “B” has a higher hierarchy “Y,” the “Y” class will also be decremented by 1. This is because one ticket has been sold that is no longer available to be sold at a higher booking class. In a parallel nesting scheme, the sale of an “M” class ticket would cause the “M” class ticket to be decremented by 1 and the “Y” class to be decremented by 1. However, the remaining booking classes in the coach cabin class would not be affected since those booking classes are independent direct subsets of the “Y” class. If a bid price scheme is implemented, only one booking class (i.e., “Y” class) is used, where the acceptable price charged for each ticket is based on the remainder of tickets in inventory. For example, at the beginning of a schedule or itinerary offering, the acceptable price per ticket is set at a lower amount. As each ticket is sold, the acceptable price per ticket increases until the acceptable price per ticket reaches a maximum value supported by the market.

As a result, one skilled in the art will appreciate that, due to the complexities of managing seat inventories, raw data associated with seat availability, as discussed, may not be readily understood by an uninformed consumer. Further, the numeral indicating the number of available seats in each booking class may often be an artificial maximum designated by a particular airline or other travel supplier to prevent unfettered disclosure of booking levels to competitors or other interested parties. For example, the default maximum may be “4,” “7,” or “9,” even though 20 seats may be available in each booking class “B” through “Q.” As a result, the number of available seats in a particular booking class may fall below the artificial maximum number of seats only when the actual number of remaining seats in that booking class is below the artificial maximum. The availability module 190 may therefore select seats based upon, for example, the least-cost-fare booking class in the appropriate cabin class having an actual number of available seats at least equal to the amount or number of persons requesting seats in the user's original query and having an available fare meeting the travel parameters set forth by the user. However, in some instances, the availability module 190 may also be configured to select available seats only from booking classes within a particular cabin class having restrictions or other fare criteria that are fulfilled by appropriate restriction or travel parameters obtained, for example, from the user's original query. That is, the availability module 190 may be configured to only select from eligible booking classes in which the user 130 fulfills the applicable restrictions or fare criteria. In such instances, the booking class selected from the eligible booking classes, under the criteria of having an actual number of available seats at least equal to the amount or number of persons requesting seats in the user's original query, is then designated as the least-cost-fare booking class.

The availability module 190 may determine or select the least-cost-fare booking class in a particular cabin class in different manners. For example, the availability module 190 may first determine, for the lowest booking class in the hierarchy of booking classes for that cabin class, the actual number of available seats and then compare the actual number of available seats in the lowest booking class to the amount of persons requesting seats. If the actual number of available seats is insufficient, the availability module 190 proceeds to determine the actual number of available seats for each successive higher booking class, until the actual number of available seats in one of the successive higher booking classes is at least equal to the amount of persons requesting seats. The corresponding higher booking class is thereby designated the first-available booking class. Further, the first-available booking class is then designated as the least-cost-fare booking class, if the first-available booking class includes the applicable fare meeting the travel parameters. Otherwise, the availability module 190 determines whether the next successive higher booking class includes the applicable fare meeting the travel parameters, if the first-available booking class does not include the applicable fare meeting the travel parameters. The availability module 190 thereafter designates the highest booking class as the least-cost-fare booking class if none of the ranked booking classes includes the applicable fare meeting the travel parameters.

In other instances, the availability module 190 may first determine the actual number of available seats for the highest booking class in the hierarchy of booking classes for the particular cabin class and then compare the actual number of available seats in the highest booking class to the amount of persons requesting seats. If the actual number of available seats is sufficient, the availability module 190 then determines the actual number of available seats for each successive lower booking class, until the actual number of available seats in one of the successive lower booking classes is less than the amount of persons requesting seats. The booking class immediately preceding the lower booking class having the insufficient number of seats (the next higher booking class in the hierarchy) is thereby designated as the least price booking class. However, if the actual number of available seats in any of the booking classes for that cabin class is not less than the amount of persons requesting seats, the lowest booking class is designated as the first-available booking class. The first-available booking class is designated as the least-cost-fare booking class, if the first-available booking class includes the applicable fare meeting the travel parameters. The availability module 190 then determines whether the next successive higher booking class includes the applicable fare meeting the travel parameters, if the first-available booking class does not include the applicable fare meeting the travel parameters. The availability module 190 thereafter designates the lowest booking class as the least-cost-fare booking class, if the actual number of available seats in any of the booking classes is not less than the amount of persons requesting seats, or designates the highest booking class as the least-cost-fare booking class if none of the ranked booking classes includes the applicable fare meeting the travel parameters. Though the description of the functions of the availability module 190 are presented herein in contemplation of a serially nested inventory process, one skilled in the art will appreciate that the available seat and least-cost-fare booking class designation schemes may be appropriately altered for other inventory schemes, such as a parallel nesting scheme, and that the examples presented herein are not intended to be restrictive in this manner.

Once seat availability is determined by the availability module 190 for each schedule, or travel segment therein, determined by the scheduler module 180, the pricing module 200 applies appropriate rules or other functionality for determining pricing of the available seats and is capable of ranking the same according to, for example, price and/or restrictions. That is, the pricing module 200 may consider the booking class having the designated available seats, as well as other parameters such as restrictions or other fare criteria, in providing a price of a particular schedule or travel segment. In this manner, once the compilation is completed, a summary is presented in direct response to the user 130 of flights or schedules meeting the travel criteria submitted by the user 130, wherein the schedules may be ranked according to, for example, price, travel time, number of stops, or carrier. Such a summary may be provided to the user 130 as an indicia such as, for example, an image of a web page or a text message on the user's computer 130. The summary may include, for example, one or more schedules, each including flight information such as carrier, departure and arrival times, and flight duration, as well as the booking code (least-cost-fare booking class) and corresponding price for that flight.

However, ranking by price often lacks other information, such as the amount of seats available at that price, which does not allow the user 130 to make an informed decision at the time of the query and subsequent study of the summary or indicia provided by the system 120. In some instances, the user 130 may proceed to choose a particular flight and take further steps to request more information about a particular quoted schedule or price, or actually proceed to purchase the tickets through a purchase module 210. In such instances, the user 130 may be provided with some indication of seat availability, though the user 130 may have to search or navigate through the online travel provider web site and/or may be required to have knowledge of the availability schemes implemented by the various carriers. For example, upon selecting a particular flight or schedule, the user 130 may be provided with a seat map of the particular cabin class and/or booking class for which a travel schedule and price was quoted, showing the available seats, so as to allow the user 130 to select one or more seats within that cabin class and/or booking class, or to change seat assignments. That is, a map of the entire coach cabin class section may be shown with indications of occupied and unoccupied seats based on previous purchase or reservation. Such a representation, however, does not provide the user 130 with much, if any, indication with respect to the amount of seats available at a quoted price (in a particular booking class). In other instances, after selecting a particular flight, the user 130 may be provided with information such as “Y7 B7 H7 K7 M7 Q7,” which represents carrier designations for available seats in a cabin class. Such terminology may be indecipherable by an uninformed consumer unfamiliar with such terminology used by the carriers and thus does not provide the user 130 with much, if any, indication with respect to the amount of seats available at a quoted price. In either instance, the seat availability to quoted price correlation is indirectly provided to the user 130 and it may often be inconvenient or cumbersome to obtain such information. In further instances, the user 130 may not even proceed to request more information and thus may not receive any indication of seat availability at a quoted price.

As such, particularly advantageous embodiments of the present invention provide remaining seat availability in a particular booking class for a quoted price to the user 130, in direct response to the user's original query. That is, in the systems and methods described herein, the summary of flight schedules presented to the user 130 in response to the travel parameters provided by the user 130 represents a direct response to the user 130. More particularly, the indicia, for example, on the web page or in the text message, illustrating or describing the summary of flights meeting the travel criteria set forth by the user 130 is the direct response to the user 130. Accordingly, embodiments of the present invention include an indicia of the amount of remaining seats in the least-cost-fare booking class for each schedule, in correlation with the quoted price, when the summary of such schedules/prices is directly presented to the user 130.

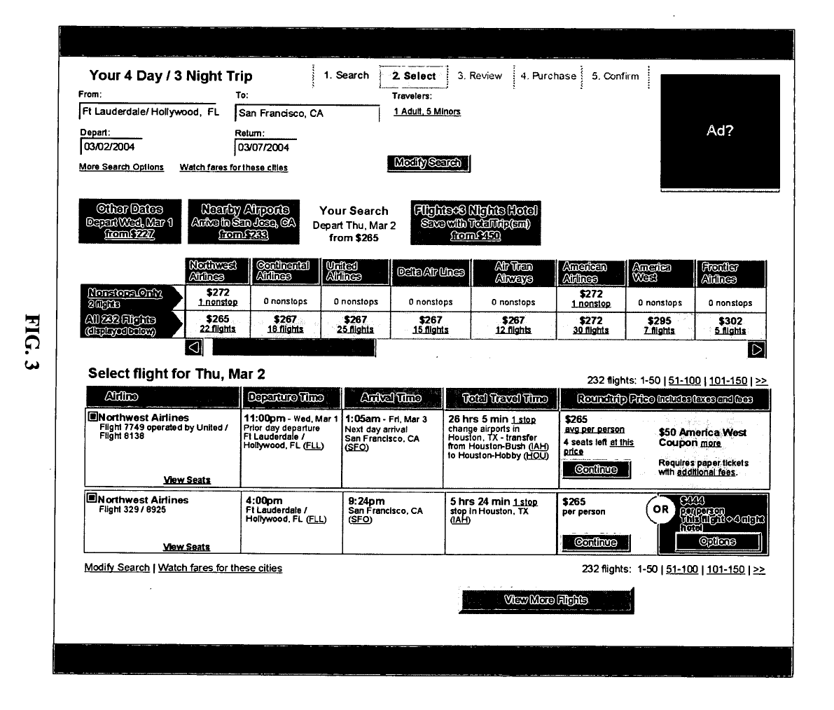

As shown in FIG. 2, such an indicia may be determined from the least-cost-fare booking class for each schedule. For example, for a single traveler, and assuming a serial nesting structure and that all restrictions are met by the traveler, Row 1 (AA 301) shows the lowest booking class in a coach cabin class having at least one available seat as being class “N.” However, since all classes “Y” through “N” each indicate 7 available seats, class “N” in actuality has at least the artificial maximum amount of seats available. In such instances, the indicia directly provided to the user 130 in the summary for that flight may show “at least 7 seats available at this price” or, in some instances, no indicia may be provided to the user 130, thus indicating to the user 130 that seat availability for this particular cabin class and for this booking class on the selected flight is relatively good and therefore, immediate purchase may not be required to buy a seat at this price at a later time. On the other hand, Row 5 (AA 305) shows that no seats are available in class “N” and that three seats are actually available in class “V.” As such, the quoted price for this flight schedule would be one of the three seats in the least-cost-fare booking class “V” in the coach cabin class, if the “V” booking class includes an applicable fare meeting the travel parameters of the user 130. In addition, since the higher class “L” indicates the availability of six seats and the higher classes “M” through “Y” each indicate the availability of 7 seats (artificial maximum), the indicia directly provided to the user 130 in the summary for that flight may show, for example, “three seats available at this price.” If only one seat were available in the “V” booking class, the indicia provided directly to the user 130 could state, for instance, “1 seat available at this price” or “last seat available at this price.” In such an instance, the user 130 would be alerted in the summary that purchase of a ticket at the corresponding quoted price would need immediate attention to preserve a purchase at this price since only one seat remains at the quoted price and any subsequently-purchased seat in that cabin class for that flight may have a significantly higher price (for example, in the “L” booking class). FIG. 3 illustrates an example of a direct response to the user 130 to a query, wherein, for example, the schedule and price quoted to the user 130 for Northwest Airlines flight 7749/8138 particularly indicates a price of $265 per person, with 4 seats left at the quoted price, while Northwest Airlines flight 329/8925 particularly indicates a price of $265 per person, with no indication of how many seats are left at the quoted price.

Thus, embodiments of the present invention provide a device, system, and method capable of providing an indicia of the number of available seats in a least-cost-fare booking class to the user in direct response to a query from the user regarding particular travel plans. That is, in response to the user's query regarding particular travel parameters, embodiments of the present invention provide the user with one or more corresponding travel schedules, each having a price or cost associated therewith, in direct response to the query. Advantageously, the direct response also includes an indicia of how many seats or tickets remain available in that particular booking class, at the time of the response and at the quoted price. The user is then able to make an objective purchasing decision based upon the actual availability, or lack thereof, of tickets corresponding to the quoted price. When provided the immediate seat availability for a quoted price, the user may be able to assess the likelihood of seat availability at a later time, and thereby make a better judgment of the timing of the purchase. Embodiments of the present invention may thus be able to capture sales for a travel provider that may otherwise have been lost due to higher price quotes for a travel ticket at a later time due to procrastination on the part of the user, while also provide savings and value to both the user and the travel provider.

Many modifications and other embodiments of the inventions set forth herein will come to mind to one skilled in the art to which these inventions pertain having the benefit of the teachings presented in the foregoing descriptions and the associated drawings. For example, in addition to the indicia of how many seats or tickets remain available in that particular booking class, at the time of the response and at the quoted price, the customer 130 may also be, in some instances, provided with an indicia of the attributes of the remaining seats. That is, for each remaining seat at the quoted price, the customer 130 may be provided with information regarding, for instance, whether the seat is an aisle, middle, or window seat, and whether the seat is in an exit row, at a bulkhead, and/or includes enhanced legroom. Such examples, however, are not intended to be limiting with respect to the seat attributes which may be provided to the customer 130 in addition to the seat availability at the quoted price.

In another example, the principles discussed herein with respect to providing remaining seat availability at a quoted price may also be extended to package or bulk tickets, wherein seat or ticket availability at a quoted price for such package or bulk tickets in the alternative or in addition to the seat availability at a quoted price for a standalone flight schedule. That is, the remaining seat availability at a quoted price has been described in the examples presented herein in terms of airline flights only. However, in some instances, the customer 130 may choose to request information on packages that may include, for example, flight and hotel or flight, hotel, and rental car. In other instances, such package options may be presented to the customer 130, without request, to demonstrate such alternatives to the customer 130 planning a trip. For example, in response to a customer query, the customer 130 may be presented with a flight schedule at a quoted price and with a specified amount of seats available at that price (i.e. Flight 1234 may have a ticket for $100.00, with 3 seats remaining at that price), and then be presented with a package option as an alternative (i.e. the package offer may include a ticket on Flight 1234 with a one night stay at Hotel X for $250.00, with 2 such package offers remaining at that price). Such a scenario is shown, for example, in FIG. 3, wherein Northwest Airlines flight 329/8925 particularly indicates a price of $265 per person for the flight(s) alone, but also presents an alternative showing the flight(s) plus four night hotel stay for $444 per person. As with the cabin class/booking class structure described above, such package or bulk tickets may have limited availability. In addition, the flight portion of package or bulk tickets may have seats in a booking class which may not necessarily correspond to a booking class for a standalone flight ticket. That is, the package or bulk ticket may require a particular booking class that may not necessarily be the same as the booking class for the same flight or schedule selected for a customer 130 seeking only a flight ticket. For instance, the standalone flight schedule may specify the ticket as being in class “Q,” while the package offer may specify the flight ticket as being in class “M.” Further, the package or bulk ticket may include independent restrictions or fare requirements that must be evaluated against the parameters supplied by the customer 130 in order to determine customer eligibility. Thus, one skilled in the art will appreciate that the same or similar methodology described herein as being applied to a standalone ticket may also be applied to package offers provided by a travel provider.

In still another example, the principles discussed herein with respect to providing remaining seat availability at a quoted price may also be extended to situations in which a party of multiple travelers may be provided with seat availability at a quoted price on a split-party basis. That is, in a query for schedules or tickets for multiple travelers in a single party, the multiple travelers may be split between cabin classes (i.e. first cabin class and coach cabin class), or between booking classes in a particular cabin class (i.e. between booking classes “M” and “Q” in a coach cabin class). The split with respect to the party may be done according to customer parameters, wherein the customer 130 decides how to split the party, or the split may be assigned by the system 120 based upon, for example, seat availability (i.e. for a party of four travelers, there may be only 2 seats available in lower price class “Q,” while 7 seats are available in higher price class “M”) or traveler category (i.e. the party may include a family of 2 adults, one child, and one senior citizen, wherein, for a particular schedule, class “Q” has 2 adult category tickets remaining at a certain adult price, but does not have any child category tickets remaining or any additional adult category tickets remaining that may be re-designated to a senior citizen ticket, while class “M” has 2 child category tickets remaining at a corresponding child's price, as well as 4 adult category tickets remaining at a corresponding adult's price) In such instances, each portion or category of the particular party may be independently addressed by the system 120 for determining seat availability at a corresponding quoted price. For instance, in the family party situation, the system 120 may search the senior citizen parameter and return a price quote in class “Q” with an indication of 2 available seats at that price, while the child parameter would be searched separately (but concurrently) and return a price quote in class “M” with an indication of 2 available seats at that price. Still further, the adult category would be searched separately and concurrently and return a price quote in class “M” with 4 seats remaining at the quoted price. In the alternative, the adult category tickets may be quoted in the “Q” class, while the senior citizen ticket may be quoted in the “M” class. The system 120 could also include functionality to determine, for example, which scenario would provide the net lowest cost to the family party. That is, having the two adults in the “Q” class and the senior citizen in the “M” class may provide a net lower cost than having the senior citizen in the “Q” class and the two adults in the “M” class. Accordingly, the family party would be split across booking classes and traveler categories, but could also be split across cabin classes, if necessary or requested. Thus, one skilled in the art will also appreciate that other scenarios with respect to the split party situation could therefore be addressed according to embodiments of the present invention.

Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. An intermediary computer device configured to implement a system for determining a remaining amount of seats available in at least one booking class, each booking class having a maximum number of available seats and a plurality of fares associated therewith, the intermediary computer device being configured to be in communication with a computer network so as to be capable of communicating with a discrete computer device adapted to be used by a user, said intermediary computer device comprising:
a processing portion for receiving a query from a user, the query being associated with travel parameters and including an amount of persons requesting seats and at least two connect points to be traversed, the query being received from the discrete computer device over the computer network;
a processing portion for obtaining at least one schedule between the at least two connect points, each schedule having at least one travel segment, and each travel segment having at least one cabin class associated therewith, wherein each cabin class includes at least one booking class, the booking classes in each respective cabin class being ranked according to a booking class criteria so as to include a highest booking class and a lowest booking class, the lowest booking class being a subset of the highest booking class;
a processing portion for selecting a least-cost-fare booking class from the ranked booking classes, the least-cost-fare booking class being the ranked booking class having an actual number of available seats at least equal to the amount of persons requesting seats and an applicable fare from the plurality of fares meeting the travel parameters associated with the query; and
a processing portion for providing an indicia of the number of available seats in the least-cost-fare booking class to the user in direct response to the query, the indicia being provided to the discrete computer device over the computer network.

2. An intermediary computer device according to claim 1 wherein, if the actual number of available seats in the least-cost-fare booking class is equal to the maximum number of available seats, the processing portion for providing an indicia is further configured to provide an indicia to the user that at least the maximum number of available seats is available in the least-cost-fare booking class.

3. An intermediary computer device according to claim 1 wherein, if the actual number of available seats in the least-cost-fare booking class is less than the maximum number of available seats, the processing portion for providing an indicia is further configured to provide an indicia to the user that the actual number of available seats is available in the least-cost-fare booking class.

4. An intermediary computer device according to claim 1 wherein the processing portion for determining the least-cost-fare booking class is further configured to:
determine, for the lowest booking class, the actual number of available seats;
compare the actual number of available seats in the lowest booking class to the amount of persons requesting seats;
determine the actual number of available seats for each successive higher booking class, if the actual number of available seats in the lowest booking class is less than the amount of persons requesting seats, until the actual number of available seats in one of the successive higher booking classes is at least equal to the amount of persons requesting seats, the one of the successive higher booking classes thereby being a first-available booking class;
designate the first-available booking class as the least-cost-fare booking class if the first-available booking class includes the applicable fare meeting the travel parameters;
determine whether the next successive higher booking class includes the applicable fare meeting the travel parameters, if the first-available booking class does not include the applicable fare meeting the travel parameters; and
designate the highest booking class as the least-cost-fare booking class if none of the ranked booking classes includes the applicable fare meeting the travel parameters.

5. An intermediary computer device according to claim 1 wherein the processing portion for determining the least-cost-fare booking class is further configured to:
determine the actual number of available seats for the highest booking class;
compare the actual number of available seats in the highest booking class to the amount of persons requesting seats;
determine the actual number of available seats for each successive lower booking class, if the actual number of available seats in the highest booking class is greater than the amount of persons requesting seats, until the actual number of available seats in one of the successive lower booking classes is less than the amount of persons requesting seats, the booking class immediately preceding the one of the successive lower booking classes thereby being a first-available booking class;
designate the first-available booking class as the least-cost-fare booking class if the first-available booking class includes the applicable fare meeting the travel parameters;
determine whether the next successive higher booking class includes the applicable fare meeting the travel parameters, if the first-available booking class does not include the applicable fare meeting the travel parameters;
designate the lowest booking class as the least-cost-fare booking class if the actual number of available seats in any of the booking classes is not less than the amount of persons requesting seats; and
designate the highest booking class as the least-cost-fare booking class if none of the ranked booking classes includes the applicable fare meeting the travel parameters.

6. An intermediary computer device according to claim 1 wherein the processing portion for obtaining at least one schedule is further configured to obtain the at least one schedule from at least one of a real-time schedule source and a cached schedule source capable of communicating with the intermediary computer device.

7. An intermediary computer device according to claim 1 wherein each booking class is associated with a restriction criteria and the system further includes a processing portion configured to:
determine, from the query, at least one restriction parameter indicated thereby;
compare the at least one restriction parameter to the restriction criteria for each booking class so as to determine at least one fulfilled restriction criteria; and
determine at least one eligible booking class corresponding to the at least one fulfilled restriction criteria.

8. An intermediary computer device according to claim 7 wherein the processing portion for selecting the least-cost-fare booking class is further configured to select the least-cost-fare booking class from the ranked eligible booking classes.

9. A system for determining a remaining amount of seats available in at least one booking class, each booking class having a maximum number of available seats and a plurality of fares associated therewith, said system comprising:
a first computer device adapted to be used by a user and configured to be capable of communicating with a computer network; and
a second computer device configured to be in communication with the computer network so as to be capable of communicating with the first computer device, said second computer device comprising:
a processing portion for receiving a query from a user, the query being associated with travel parameters and including an amount of persons requesting seats and at least two connect points to be traversed, the query being received by the second computer device from the first computer device over the computer network;
a processing portion for obtaining at least one schedule between the at least two connect points, each schedule having at least one travel segment, and each travel segment having at least one cabin class associated therewith, wherein each cabin class includes at least one booking class, the booking classes in each respective cabin class being ranked according to a booking class criteria so as to include a highest booking class and a lowest booking class, the lowest booking class being a subset of the highest booking class;
a processing portion for selecting a least-cost-fare booking class from the ranked booking classes, the least-cost-fare booking class being the booking class having an actual number of available seats at least equal to the amount of persons requesting seats and an applicable fare from the plurality of fares meeting the travel parameters associated with the query; and
a processing portion for providing an indicia of the number of available seats in the least-cost-fare booking class to the user in direct response to the query, the indicia being provided to the first computer device over the computer network from the second computer device.

10. A system according to claim 9 wherein, if the actual number of available seats in the least-cost-fare booking class is equal to the maximum number of available seats, the processing portion for providing an indicia is further configured to provide an indicia to the user that at least the maximum number of available seats is available in the least-cost-fare booking class.

11. A system according to claim 9 wherein, if the actual number of available seats in the least-cost-fare booking class is less than the maximum number of available seats, the processing portion for providing an indicia is further configured to provide an indicia to the user that the actual number of available seats is available in the least-cost-fare booking class.

12. A system according to claim 9 wherein the processing portion for determining the least-cost-fare booking class is further configured to:
determine, for the lowest booking class, the actual number of available seats;
compare the actual number of available seats in the lowest booking class to the amount of persons requesting seats;
determine the actual number of available seats for each successive higher booking class, if the actual number of available seats in the lowest booking class is less than the amount of persons requesting seats, until the actual number of available seats in one of the successive higher booking classes is at least equal to the amount of persons requesting seats, the one of the successive higher booking classes thereby being a first-available booking class;
designate the first-available booking class as the least-cost-fare booking class if the first-available booking class includes the applicable fare meeting the travel parameters;
determine whether the next successive higher booking class includes the applicable fare meeting the travel parameters, if the first-available booking class does not include the applicable fare meeting the travel parameters; and
designate the highest booking class as the least-cost-fare booking class if none of the ranked booking classes includes the applicable fare meeting the travel parameters.

13. A system according to claim 9 wherein the processing portion for determining the least-cost-fare booking class is further configured to:
determine the actual number of available seats for the highest booking class;
compare the actual number of available seats in the highest booking class to the amount of persons requesting seats; and
determine the actual number of available seats for each successive lower booking class, if the actual number of available seats in the highest booking class is greater than the amount of persons requesting seats, until the actual number of available seats in one of the successive lower booking classes is less than the amount of persons requesting seats, the booking class immediately preceding the one of the successive lower booking classes thereby being a first-available booking class;
designate the first-available booking class as the least-cost-fare booking class if the first-available booking class includes the applicable fare meeting the travel parameters;
determine whether the next successive higher booking class includes the applicable fare meeting the travel parameters, if the first-available booking class does not include the applicable fare meeting the travel parameters;
designate the lowest booking class as the least-cost-fare booking class if the actual number of available seats in any of the booking classes is not less than the amount of persons requesting seats; and
designate the highest booking class as the least-cost-fare booking class if none of the ranked booking classes includes the applicable fare meeting the travel parameters.

14. A system according to claim 9 wherein the processing portion for obtaining at least one schedule is further configured to obtain the at least one schedule from at least one of a real-time schedule source and a cached schedule source capable of communicating with the second computer device.

15. A system according to claim 9 wherein each booking class is associated with a restriction criteria and the system further includes a processing portion configured to:
determine, from the query, at least one restriction parameter indicated thereby;
compare the at least one restriction parameter to the restriction criteria for each booking class so as to determine at least one fulfilled restriction criteria; and
determine at least one eligible booking class corresponding to the at least one fulfilled restriction criteria.

16. A system according to claim 15 wherein the processing portion for selecting a least-cost-fare booking class is further configured to select the least-cost-fare booking class from the ranked eligible booking classes.

17. A method of determining a remaining amount of seats available in at least one booking class, each booking class having a maximum number of available seats and a plurality of fares associated therewith, said method being implemented over a computer network and comprising:
receiving a query from a user over the computer network, the query being associated with travel parameters and including an amount of persons requesting seats and at least two connect points to be traversed;
obtaining at least one schedule between the at least two connect points, each schedule having at least one travel segment, and each travel segment having at least one cabin class associated therewith, wherein each cabin class includes at least one booking class, the booking classes in each respective cabin class being ranked according to a booking class criteria so as to include a highest booking class and a lowest booking class, the lowest booking class being a subset of the highest booking class;
selecting a least-cost-fare booking class from the ranked booking classes, the least-cost-fare booking class being the booking class having an actual number of available seats at least equal to the amount of persons requesting seats and an applicable fare from the plurality of fares meeting the travel parameters associated with the query; and
providing an indicia of the number of available seats in the least-cost-fare booking class to the user over the computer network in direct response to the query.

18. A method according to claim 17 wherein, if the actual number of available seats in the least-cost-fare booking class is equal to the maximum number of available seats, providing an indicia further comprises providing an indicia to the user that at least the maximum number of available seats is available in the least-cost-fare booking class.

19. A method according to claim 17 wherein, if the actual number of available seats in the least-cost-fare booking class is less than the maximum number of available seats, providing an indicia further comprises providing an indicia to the user that the actual number of available seats is available in the least-cost-fare booking class.

20. A method according to claim 17 wherein determining the least-cost-fare booking class further comprises:
determining, for the lowest booking class, the actual number of available seats;
comparing the actual number of available seats in the lowest booking class to the amount of persons requesting seats;
determining the actual number of available seats for each successive higher booking class, if the actual number of available seats in the lowest booking class is less than the amount of persons requesting seats, until the actual number of available seats in one of the successive higher booking classes is at least equal to the amount of persons requesting seats, the one of the successive higher booking classes thereby being a first-available booking class;
designating the first-available booking class as the least-cost-fare booking class if the first-available booking class includes the applicable fare meeting the travel parameters;
determining whether the next successive higher booking class includes the applicable fare meeting the travel parameters, if the first-available booking class does not include the applicable fare meeting the travel parameters; and
designating the highest booking class as the least-cost-fare booking class if none of the ranked booking classes includes the applicable fare meeting the travel parameters.

21. A method according to claim 17 wherein determining the least-cost-fare booking class further comprises:
determining the actual number of available seats for the highest booking class;
comparing the actual number of available seats in the highest booking class to the amount of persons requesting seats;
determining the actual number of available seats for each successive lower booking class, if the actual number of available seats in the highest booking class is greater than the amount of persons requesting seats, until the actual number of available seats in one of the successive lower booking classes is less than the amount of persons requesting seats, the booking class immediately preceding the one of the successive lower booking classes thereby being a first-available booking class;
designating the first-available booking class as the least-cost-fare booking class if the first-available booking class includes the applicable fare meeting the travel parameters;
determining whether the next successive higher booking class includes the applicable fare meeting the travel parameters, if the first-available booking class does not include the applicable fare meeting the travel parameters;
designating the lowest booking class as the least-cost-fare booking class if the actual number of available seats in any of the booking classes is not less than the amount of persons requesting seats; and
designating the highest booking class as the least-cost-fare booking class if none of the ranked booking classes includes the applicable fare meeting the travel parameters.

22. A method according to claim 17 wherein obtaining at least one schedule further comprises obtaining at least one schedule from at least one of a real-time schedule source and a cached schedule source.

23. A method according to claim 17 wherein each booking class is associated with a restriction criteria and the method further comprises:
determining, from the query, at least one restriction parameter indicated thereby;
comparing the at least one restriction parameter to the restriction criteria for each booking class so as to determine at least one fulfilled restriction criteria; and
determining at least one eligible booking class corresponding to the at least one fulfilled restriction criteria.

24. A method according to claim 23 wherein selecting the least-cost-fare booking class further comprises selecting the least-cost-fare booking class from the ranked eligible booking classes.

25. A method according to claim 17 wherein receiving a query further comprises receiving a query from a user, via a first computer device, at a second computer device capable of communicating therewith and configured to select the least-cost-fare booking class.

26. A method according to claim 17 wherein obtaining at least one carrier schedule further comprises obtaining at least one carrier schedule, at a second computer device, from a carrier schedule source capable of communicating therewith.

27. A method according to claim 17 wherein providing an indicia further comprises providing an indicia of the number of available seats in the least-cost-fare booking class to the user via a first computer device adapted to be used thereby.
